(19) United States
(12) Patent Application Publication
(10) Pub. No.: US 2016/0239865 A1
(43) Pub. Date: Aug. 18, 2016

(54) METHOD AND DEVICE FOR ADVERTISEMENT CLASSIFICATION

(71) Applicant: TENCENT TECHNOLOGY (SHENZHEN) COMPANY LIMITED, Shenzhen (CN)

(72) Inventors: YAJUAN SONG, Shenzhen (CN); LEI XIAO, Shenzhen (CN); JINJING LIU, Shenzhen (CN); SHAOFENG HU, Shenzhen (CN)

(73) Assignee: TENCENT TECHNOLOGY (SHENZHEN) COMPANY LIMITED

(21) Appl. No.: 15/140,793

(22) Filed: Apr. 28, 2016

Related U.S. Application Data
(63) Continuation of application No. PCT/CN2014/086149, filed on Sep. 9, 2014.

(30) Foreign Application Priority Data
Oct. 28, 2013 (CN) 2013-10516732.1

(51) Int. Cl. G06Q 30/02; G06N 5/02

(52) U.S. Cl. CPC G06Q 30/0251; G06N 5/022

(57) ABSTRACT

The present disclosure provides a method and a device for advertisement classification, a server and a storage medium in the field of information technologies. The method includes: obtaining, according to text information of an advertisement to be classified, a plurality of feature words of the text information; acquiring a Term Frequency-Inverse Document Frequency value of each feature word from the plurality of feature words as a weight value of the feature word, according to statistical information of the feature word in the text information and statistical information of the feature word in known product titles; and acquiring a category of the advertisement according to the weight values of the plurality of feature words, classification information of the advertisement and a preset classification model. Accordingly, selecting the data from the advertisement in a manner of manual labeling is avoided, so that the time taken for advertisement classification is reduced.

### CROSS-REFERENCE TO RELATED APPLICATION

This application is a continuation of PCT/CN 2014/086,149, filed on Sep. 9, 2014, which claims the benefit of Chinese Patent Application No. 201310516732.1 filed on Oct. 28, 2013 by Shenzhen Tencent Computer System Co., Ltd., entitled “METHOD AND DEVICE FOR ADVERTISEMENT CLASSIFICATION, AND SERVER.” The content of the above-mentioned applications is incorporated herein by reference in its entirety.

### TECHNICAL FIELD

The present disclosure relates to the field of information technologies, and in particular to a method and a device for advertisement classification, a server and a storage medium.

### BACKGROUND

With the rapid development of advertisement, there is a need to push an advertisement exactly to a user who is interested in this advertisement. In the prior art, this need is generally satisfied via advertisement classification, that is, the advertisements are classified into different categories so that advertisements in a certain category are pushed to target users of this category.

Generally, during the advertisement classification, text information of an advertisement is represented by a characteristic vector. Data in the text information of the advertisement may be labeled manually, then feature extraction is performed on the labeled data to obtain a feature related to the semantics of a category to which the data belongs, and finally the advertisement is classified according to the obtained feature and a classification model such as a Naive Bayesian classification model or a Support Vector Machine (SVM) classification model. Consequently, the advertisements may be pushed according to the categories obtained by classifying the advertisements as per the classification models. The classified advertisements may be designed by the enterprises autonomously in terms of promotion time, promotion region, budget and the like, reduce the advertisement costs of the enterprises, and increase a click through rate thereof, and therefore attract intensive attention from the enterprises.

However, during the advertisement classification, the data in an advertisement are usually selected by means of manual labeling, resulting in a long time for the advertisement classification. Although a good effect of advertisement classification may be obtained via the SVM classification model and the Naive Bayesian classification model, the precision of classifying complex and diverse advertisements via the feature obtained from the text information and a separate classification model is low.

### SUMMARY

In order to solve the problem of the prior art, embodiments of consistent with the present disclosure provide a method and a device for advertisement classification, a server and storage medium.

Another aspect of the present disclosure provides an embodiment consistent with the present disclosure provides a method for advertisement classification, including: obtaining, according to text information of an advertisement to be classified, a plurality of feature words of the text information; acquiring a Term Frequency-Inverse Document Frequency value of each feature word from the plurality of feature words as a weight value of the feature word, according to statistical information of the feature word in the text information and statistical information of the feature word in known product titles; and acquiring a category of the advertisement according to the weight values of the plurality of feature words, classification information of the advertisement and a preset classification model.

Another aspect of the present disclosure provides an embodiment consistent with the present disclosure provides a device for advertisement classification, including: a feature word acquiring module, which is configured for obtaining, from text information of an advertisement to be classified, a plurality of feature words of the text information; a feature word weight value determining module, which is configured for acquiring a Term Frequency-Inverse Document Frequency value of each feature word from the plurality of feature words as a weight value of the feature word, according to statistical information of the feature word in the text information and statistical information of the feature word in known product titles; and a category determining module category determining module, which is configured for acquiring a category of the advertisement according to the weight values of the plurality of feature words, classification information of the advertisement and a preset classification model.

Another aspect of the present disclosure provides an embodiment consistent with the present disclosure provides a server including a processor and a storage, which are connected with each other. The processor is configured for obtaining, according to text information of an advertisement to be classified, a plurality of feature words of the text information. The processor is further configured for acquiring a Term Frequency-Inverse Document Frequency value of each feature word from the plurality of feature words as a weight value of the feature word, according to statistical information of the feature word in the text information and statistical information of the feature word in known product titles. The processor is further configured for acquiring a category of the advertisement according to the weight values of the plurality of feature words, classification information of the advertisement and a preset classification model.

Another aspect of the present disclosure provides an embodiment consistent with the present disclosure provides a storage medium containing computer-executable instructions, where the computer-executable instructions, when executed by a computer processor, are configured to perform a method for advertisement classification including: obtaining, according to text information of an advertisement to be classified, a plurality of feature words of the text information; acquiring a Term Frequency-Inverse Document Frequency value of each feature word from the plurality of feature words as a weight value of the feature word, according to statistical information of the feature word in the text information and statistical information of the feature word in known product titles; and acquiring a category of the advertisement according to the weight values of the plurality of feature words, classification information of the advertisement and a preset classification model.

In embodiments consistent with the present disclosure, a plurality of feature words are obtained from the text information of an advertisement to be classified, and the product title corresponding to each preset category is regarded as a known product title and added to a corpus, to avoid selecting the data from the advertisement in a manner of manual labeling, so that the time taken for advertisement classification is reduced. At the same time, in classifying an advertisement, the server additionally introduces the feature corresponding to the classification information of the advertisement to a preset classification model for computation in order to obtain the category of the advertisement, thus avoiding the low precision in classifying the advertisement according to a feature word obtained from the text information and a separate preset classification model merely, so that the precision of advertisement classification may be improved.

### BRIEF DESCRIPTION OF THE DRAWINGS

In order to more clearly illustrate the technical solutions of the embodiments consistent with the present disclosure, the drawings accompanying to the description of the embodiments will be briefly introduced below. Apparently, the drawings accompanying to the description below illustrate only some embodiments consistent with the present disclosure, and other drawings may also be obtained by one of ordinary skills in the art according to these accompanying drawings without a creative work.

FIG. 1 is a flow chart of a method for advertisement classification according to an embodiment consistent with the present disclosure;

FIG. 2 is a flow chart of a method for advertisement classification according to an embodiment consistent with the present disclosure;

FIG. 3 is a system for embodying the flow of the establishment of a preset classification model according to an embodiment consistent with the present disclosure shown in FIG. 2;

FIG. 4 is a flow chart showing the classification of advertisements according to an embodiment consistent with the present disclosure;

FIG. 5 is a structural schematic diagram of a device for advertisement classification according to an embodiment consistent with the present disclosure; and

FIG. 6 is a structural schematic diagram of a server according to an embodiment consistent with the present disclosure.

### DETAILED DESCRIPTION OF THE EMBODIMENTS

The technical solutions in the embodiments consistent with the present disclosure will be described clearly and fully below in conjunction with the accompanying drawings. Apparently, the embodiments described form only a part of embodiments consistent with the present disclosure, rather than all potential embodiments; and the described embodiments are intended for illustrating the principle of the invention, rather than limiting the invention thereto. All other embodiments obtained by one of ordinary skills in the art in light of the embodiments consistent with the present disclosure without a creative work fall within the protection scope of the invention.

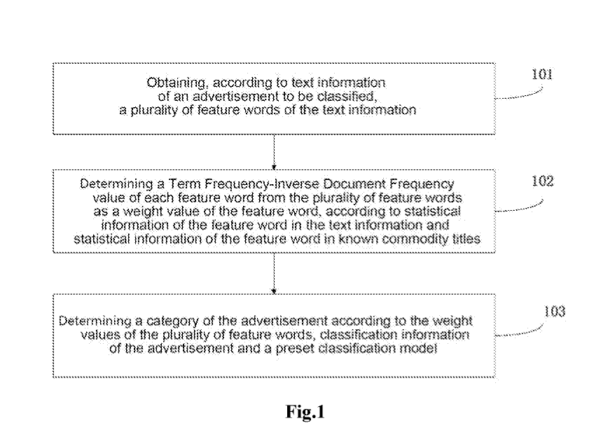

FIG. 1 is a flow chart of a method for advertisement classification according to an embodiment consistent with the present disclosure. Referring to FIG. 1, the method for advertisement classification in the present embodiment, which may be embodied by a server, includes Steps 101 to 103 below.

Step 101: obtaining by a server, according to text information of an advertisement to be classified, a plurality of feature words of the text information.

Step 102: acquiring by the server, according to statistical information of each of the feature words in the text information and statistical information of the feature word in known product titles, a Term Frequency-Inverse Document Frequency (TFIDF) value of the feature word as a weight value of the feature word. A product title may refer to a product name or a product description that provide specific information about the product, such as product name, product type, and other characteristics.

Step 103: acquiring, by the server, the category of the advertisement according to the weight values of all of the feature words, classification information of the advertisement and a preset classification model.

With the method according to the present embodiment consistent with the present disclosure, a plurality of feature words are obtained from the text information of an advertisement to be classified, and the product title corresponding to each preset category is regarded as a known product title and added to a corpus, to avoid selecting the data from the advertisement in a manner of manual labeling, so that the time taken for advertisement classification is reduced. At the same time, in classifying an advertisement, the server additionally introduces the feature corresponding to the classification information of the advertisement to a preset classification model for computation in order to obtain the category of the advertisement, thus avoiding the low precision in classifying the advertisement according to a feature word obtained from the text information and a separate preset classification model merely, so that the precision of advertisement classification may be improved.

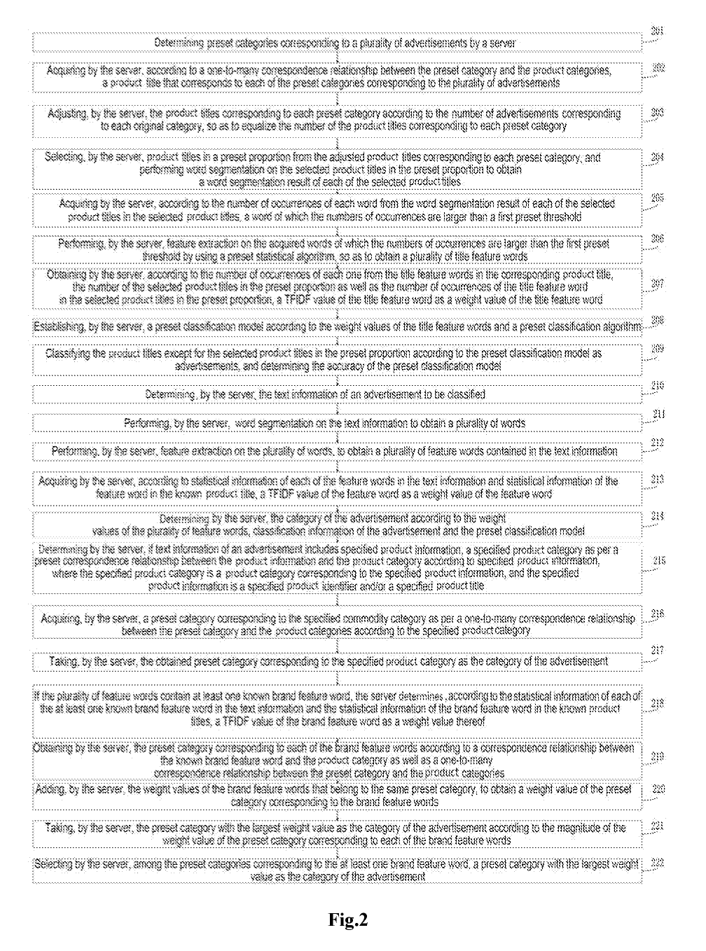

FIG. 2 is a flow chart of a method for advertisement classification according to an embodiment consistent with the present disclosure. Referring to FIG. 2, the method in the present embodiment may be embodied by a server, and include a process for establishing a preset classification model and a process for classifying an advertisement as per the preset classification model, and Steps 201 to 208 below form the process for establishing a preset classification model by the server.

Step 201: acquiring preset categories corresponding to a plurality of advertisements by a server.

It should be noted that a preset category and an original category are involved in the embodiment consistent with the present disclosure. The preset category refers to a category set by an advertising agent. Before issuing an advertisement, the advertising agent determines the preset category to which the advertisement belongs via manual classification. The original category refers to a category determined for the advertisement by the advertisement owner. The original category may be the same as or different from the preset category; for example, the advertisement owner determines the original category of a certain advertisement as a “clothing accessories” before entrusting the advertisement to the advertising agent for issuing, but the preset category determined for the advertisement by the advertising agent may be a “ornamental article” when the advertising agent issues the advertisement. Indeed, the original category may be one of the preset categories or the product categories, or the original category may have a correspondence relationship with at least one preset category or product category.

Step 202: acquiring by the server, according to a one-to-many correspondence relationship between the preset category and the product categories, a product title that corresponds to each of the preset categories corresponding to the plurality of advertisements.

The product categories herein refers to electronic-commerce product categories; for example, the product categories may include product categories on www.paipai.com, product categories on www.taobao.com, or a combination of product categories provided by several different operators. However, the product categories are not limited to the product categories from the above two shopping websites, and may also include other electronic commerce product categories. In the embodiment consistent with the present disclosure, the source of the product category is not limited.

It is found from the process of classifying a large amount of advertisements that, the text information of the advertisement is similar to the product title corresponding to the product category, that is, the feature words contained in the text information of the advertisement are the same as or similar to the feature words contained in the product title, thus the electronic-commerce commodities may be employed as the training samples. Through the obtainment of the preset category of each product in combination with the mapping relation between the preset category and the product categories, the product titles of the commodities may be used as training samples so that the product titles in the preset proportion are employed as a corpus, so as to establish a preset classification model according to the relations between a large amount of product titles and the product categories.

Specifically in Step 202, each product category corresponds to a plurality of product titles, and after the server obtains the preset categories corresponding to the plurality of advertisements, the server may obtain the product titles corresponding to each of the plurality of the obtained preset categories according to the product titles corresponding to the product category and the established one-to-many correspondence relationship between each preset category and the product categories.

For example, if the preset category is a “garment”, the product categories corresponding to the preset category include men's wear and ladies' wear, the product titles corresponding to the men's wear include a product title A and a product title B, and the product titles corresponding to the ladies' wear include a product title C, a product title D, a product title E and a product title F, then the product titles corresponding to the preset category of “garment” include the product title A, the product title B, the product title C, the product title D, the product title E and the product title F.

Step 203: adjusting, by the server, the product titles corresponding to each preset category according to the number of advertisements corresponding to each original category, so as to equalize (or balance) the number of the product titles corresponding to each preset category.

Because the number of the product titles corresponding to each of the preset categories obtained in Step 202 might be excessive, the subsequent word segmentation process for these product titles will inevitably be complicated. In order to make the subsequent word segmentation process for these product titles simple and effective, the product titles corresponding to each preset category need to be adjusted. Specifically, Step 203 includes: obtaining by the server, according to the original categories in advertisement classification information, the number of advertisements corresponding to each of the original categories, and adjusting the product titles corresponding to each preset category according to the proportion of advertisements corresponding to each of the original categories to the total advertisements, so as to equalize the number of product titles in the preset category.

In an implementation, according to the original categories in the advertisement classification information, the server obtains the number of advertisements corresponding to each of the original categories, and adjusts the product titles that correspond to at least one preset category corresponding to the original category according to the proportion of the advertisements corresponding to the original category to the total advertisements as well as the correspondence relationship between the original category and the at least one preset category, so that the proportion of the product titles that correspond to the at least one preset category corresponding to the original category to the total product titles is made close to or equal to the proportion of the advertisements corresponding to the original category to the total advertisements, so as to equalize the number of product titles in the preset category.

For example, if the number of advertisements corresponding to a certain original category is 10% of the number of the total advertisements, then during the adjustment of the number of product titles corresponding to the preset category, the total number of product titles corresponding to the first preset category and the second preset category that correspond to the original category is adjusted to be 10% of the known product titles.

It should be noted that, the original categories of advertisements may be included in the advertisement classification information, which may include an advertisement title, an advertisement description, an advertisement keyword, an original category of advertisement, an advertisement picture feature (for example, picture pixels, picture brightness, etc.), characters in an advertisement picture, etc. However, the advertisement classification information may also include other information in addition to the above information, which is not limited in the embodiments consistent with the present disclosure.

Step 204: selecting, by the server, product titles in a preset proportion from the adjusted product titles corresponding to each preset category, and performing word segmentation on the selected product titles in the preset proportion (i.e. splitting words contained in the selected product titles in the preset proportion) to obtain a word segmentation result of each of the selected product titles.

In order to verify the accuracy of the preset classification model established during the subsequent process, the adjusted product titles corresponding to each preset category are divided into two parts according to a preset proportion, where one of the two parts is used for establishing the preset classification model, and the other part is used for verifying the accuracy of the preset classification model. In addition, because the product title contains many contents, words contained in the product title are split in order to simplify the subsequent analyzing process. Therefore, Step 204 specifically includes: selecting, by the server, the product titles in the preset proportion from the adjusted product titles corresponding to each preset category as the text information of the advertisement; performing word segmentation on the selected product titles in the preset proportion; and filtering a preliminary result obtained from word segmentation to obtain a word segmentation result of each product title. Herein, the filtering includes filtering out a stop word, incorporating digits and names, filtering out an auxiliary word, etc., for example, filtering out a stop word “some” and filtering out an auxiliary word “of”.

For example, the word segmentation of a product title of “Samsung S7898 at the lowest price over the Internet, in shopping rush” obtains words of “Samsung”, “price”, “lowest”, etc.

It should be noted that, the preset proportion may be set by a technician during development, and may be adjusted by an advertising agent in use, which is not limited in the embodiments consistent with the present disclosure. In addition, the preset proportion may be 90% or 80%, etc.; however, the preset proportion may also be 100%. If the preset proportion is 100%, a product title newly added may be employed to verify the accuracy of the preset classification model during the subsequent stage of accuracy verification of the preset classification model. In the embodiment consistent with the present disclosure, the specific value of the preset proportion is not limited.

Step 205: acquiring by the server, according to the number of occurrences of each word from the word segmentation result of each of the selected product titles in the selected product titles, a word of which the numbers of occurrences are larger than a first preset threshold.

Here, the number of occurrences may be referred to as a Document Frequency (DF).

Because the word segmentation result obtained after performing word segmentation on each product title may still contains a large amount of contents, one or more words with a high occurrence frequency need be selected from the word segmentation result to represent the product title in order to simplify the subsequent analyzing process. Step 205 specifically includes: counting, by the server, the number of occurrences of each of the words from the obtained word segmentation result in the selected product titles in the preset proportion; and searching for and extracting, according to the number of occurrences of each of the words in the selected product titles in the preset proportion, the words of which the numbers of occurrences are larger than the first preset threshold.

Referring to the example at Step 204 again, if the first preset threshold is equal to 4 and the server determines, according to the number of occurrences of each of the words from the word segmentation result in the selected product titles in the preset proportion, that the numbers of occurrences of two words “Samsung” and “lowest” in the selected product titles in the preset proportion are both larger than 4, then the server acquires these two words “Samsung” and “lowest”.

It should be noted that, the first preset threshold may be set by a technician during development, and may be adjusted by an advertising agent in actual use, which is not limited in the embodiments consistent with the present disclosure. For example, when the first preset threshold is equal to 4, the server acquires, according to the number of occurrences of each of the words from the word segmentation result of each product title in the selected product titles in the preset proportion, the words of which the numbers of occurrences are larger than 4.

Step 206: performing, by the server, feature extraction on the acquired words of which the numbers of occurrences are larger than the first preset threshold by using a preset statistical algorithm, so as to obtain a plurality of title feature words.

To select a feature word that better represents the product title, a word with a high occurrence frequency is further extracted. Thus, Step 206 specifically includes: computing, by the server, a point value of each one from the words of which the numbers of occurrences are larger than the first preset threshold by using a preset statistical algorithm; and selecting a word of which the point value meets a preset rule as a title feature word according to the point value of each one from the words of which the DF is larger than the first preset threshold.

The preset statistical algorithm and the preset rule may be set by a technician during development, and may be adjusted by an advertising agent in use, which is not limited in the embodiment consistent with the present disclosure. The selecting of a word of which the point value meets the preset rule may be implemented in such a way of: (1) selecting a certain number of words with top point values; or (2) selecting the words of which the point value is larger than a third preset threshold. However, the above selection may also be implemented in other ways, and the implementing process for selecting a word of which the point value meets a preset rule is not limited in the embodiment consistent with the present disclosure.

For example, the preset statistical algorithm may be a chi-square statistics algorithm, in this case, the server substitutes the words of which the numbers of occurrences are larger than the first preset threshold, for example those two words “Samsung” and “lowest” obtained in the example of Step 205, into the following formula:

$${χ}^{2} ( t , c ) = \frac{K \times {( AD - CB )}^{2}}{( A + C ) \times ( B + D ) \times ( A + B ) \times ( C + D )}$$

where, A represents the number of product titles containing the word t among all product titles corresponding to a preset category c, B represents the number of product titles containing the word t among all product titles corresponding to preset categories except for the present category c, C represents the number of product titles that does not contain the word t among all the product titles corresponding to the preset category c, and D represents the number of product titles that does not contain the word t among all the product titles corresponding to the preset categories except for the preset category c, and K=A+B+C+D, where K represents the total number of the selected product titles in the preset proportion.

According to the above formula, a chi-square value of each one from the words of which the numbers of occurrences are larger than the first preset threshold with respect to each preset category is obtained, and then is substituted into any one of the following two formulae to compute the point value of each one from the words of which the numbers of occurrences are larger than the first preset threshold:

$${χ}_{avg}^{2} ( t ) = {\sum }_{i = 1}^{m} {p}_{r} ( {c}_{i} ) {χ}^{2} ( t , {c}_{i} ) , \\ {χ}_{avg}^{2} ( t ) = {max}_{\underline{1 < i < m}} \{ {χ}^{2} ( t , {c}_{i} ) \}$$

where, m denotes the number of the words of which the numbers of occurrences are larger than the first preset threshold, i denotes the sequence number of the word of which the number of occurrences is larger than the first preset threshold, and 1≦i≦m, Pr (ci) denotes the probability of occurrences of the preset category ci in the corpus, where the corpus refers to a training sample library for the product titles. There exists a mapping relation between the product title and the preset category, that is, a certain preset category has a correspondence relationship with one or more product titles. Pr (ci) denotes the proportion of the product titles that have a correspondence relationship with the preset category ci to total known product titles. The server may sort these words of which the numbers of occurrences are larger than the first preset threshold according to the point values of these words, for example in an order of decreasing point values, and select a preset number of words from the sorted words as the title feature words; or, the server may select, from the words of which the numbers of occurrences are larger than the first preset threshold, a plurality of words each with a point value larger than the third preset threshold as the title feature words.

Step 207: obtaining by the server, according to the number of occurrences of each one from the title feature words in the corresponding product title, the number of the selected product titles in the preset proportion as well as the number of occurrences of the title feature word in the selected product titles in the preset proportion, a TFIDF value of the title feature word as a weight value of the title feature word.

Specifically, the server counts the number of occurrences of each one from the title feature words in the corresponding product title, the number of the selected product titles in the preset proportion and the number of occurrences of the title feature word in the selected product titles in the preset proportion, and obtains the TFIDF value of the title feature word via the formula below:

$$TFIDF ( t , d ) = TF ( t , d ) * log ( \frac{N}{{n}_{i}} + 0.01 )$$

where, TFIDF (t, d) represents the weight of a word t in a product title d, TF(t,d) represents the occurrence frequency of the word t in the product title d, N denotes the total number of product titles in the corpus, and nᵢ denotes the number of product titles containing the word t in the corpus.

As such, the server takes the TFIDF value of each one from the title feature words obtained via the above formula as the weight value of the title feature word.

Step 208: establishing, by the server, a preset classification model according to the weight values of the title feature words and a preset classification algorithm.

To find a rule with which the weight values corresponding to a plurality of title feature words comply, the weight value of each of the title feature words and the preset classification algorithm are used by the server. Thus, the step 208 specifically includes: performing, by the server, machine learning according to the weight value of each of the acquired title feature words and the preset classification algorithm in the server; and establishing a preset classification model according to the result of the machine learning.

It should be noted that, the preset classification algorithm may be set by a technician during development, and may be adjusted by an advertising agent in use, which is not limited in the embodiments consistent with the present disclosure. Specifically, the preset classification algorithm may be a Naive Bayesian classification algorithm or a Support Vector Machine (SVM) classification algorithm.

Above Steps 201 to 208 form a process of establishing, by the server, a preset classification model by taking the product titles as advertisements and taking the product titles selected in a preset proportion as a corpus. After establishing the preset classification model, the server needs to determine the accuracy of the preset classification model, thereby determining whether the preset classification model can be used for classifying the advertisements. Therefore, the server needs to perform Step 209 below.

Step 209: classifying the product titles except for the selected product titles in the preset proportion according to the preset classification model as advertisements, and determining the accuracy of the preset classification model.

Specifically, Step 209 may include Steps 209a to 209g below.

Step 209a: taking, by the server, the product titles except for the selected product titles in the preset proportion as advertisements, and performing word segmentation on each one from the product titles except for the selected product titles in the preset proportion, to obtain a word segmentation result of the product title.

To simplify the analyzing process, the server needs to extract some representative words from the product titles except for the selected product titles in the preset proportion; and for the ease of the extraction, the server needs to perform word segmentation on these product titles beforehand. Specifically in Step 209a, the server takes the product titles except for the selected product titles in the preset proportion as the test samples. Step 209a has the same principle as Step 204, and hence is not discussed again here.

Step 209b: performing, by the server, feature extraction on the words in the word segmentation result of each of the product titles, to obtain a plurality of words.

To select the representative words from the product title, the server may preset a plurality of feature words, so that the feature extraction is performed on the words in the word segmentation result of each of the product titles with reference to the plurality of preset feature words. Thus, Step 209b specifically includes: performing, by the server, feature extraction on the words in the word segmentation result of each of the product titles with reference to the plurality of preset feature words, to obtain a plurality of words which are the same as the preset feature words.

The plurality of preset feature words may be obtained by the server after Step 206 in the process for establishing the preset classification model.

For example, in the case of a product title of “2013 new-style autumn garment, middle-aged men's garment, coat, men's relax jacket”, word segmentation on the product title by the server will result in a word segmentation result of “autumn garment”, “men's garment”, “coat” and “jacket”, and if the plurality of feature words preset by the server contain “men's garment” and “autumn garment”, the server obtains words of “men's garment” and “autumn garment” from the feature extraction performed on the words in the word segmentation result of “autumn garment”, “men's garment”, “coat” and “jacket”.

Step 209c: acquiring by the server, according to the number of occurrences of each word from the plurality of words (which are obtained from the feature extraction) in the product title corresponding to the word, the number of the product titles except for the selected product titles in the preset proportion as well as the number of occurrences of the word in the product titles except for the selected product titles in the preset proportion, a TFIDF value of the word as the weight value of the word.

To obtain the importance of the plurality of words (which are obtained from the feature extraction) in the product titles except for the selected product titles in the preset proportion, the weight values of the plurality of words are calculated. Step 209c has the same principle as Step 207, and hence is not discussed again here.

Step 209d: inputting, by the server, the weight values of the plurality of words to the preset classification model for computation, to obtain a category corresponding to each of the product titles except for the selected product titles in the preset proportion.

To determine whether the category obtained in classifying a product title via the preset classification model is the same as a preset category of the product title, the weight values of the plurality of words obtained from the word segmentation and feature extraction on the product title are inputted to the preset classification model. Specifically, Step 209d includes: inputting, by the server, the weight values of the plurality of words into the preset classification model for computation, to obtain the category corresponding to each product title from the product titles except for the selected product titles in the preset proportion according to the computation result of the preset classification model.

Step 209e: determining, by the server, whether the obtained category corresponding to each of the product titles except for the selected product titles in the preset proportion is the same as the preset category corresponding to the product title.

Specifically, after obtaining the category corresponding to each of the product titles except for the selected product titles in the preset proportion, the server determines whether the obtained category corresponding to each of the product titles is the same as the preset category corresponding to the product title according to the correspondence relationship between each of the preset categories and the product titles that is acquired in Step 202, and counts, among the product titles except for the selected product titles in the preset proportion, the number of product titles, to which the obtained categories correspond are respectively the same as the preset categories corresponding to these product titles.

For example, if the category corresponding to a certain product title obtained by the server at Step 209d is “mobile phone”, the server obtains the preset category corresponding to the product title according to the correspondence relationship between the preset category and the product titles, and determines whether the obtained preset category corresponding to the product title is “mobile phone”.

If the number of product titles, to which the categories correspond obtained from the advertisement classification are respectively the same as the preset categories corresponding to these product titles, reaches a second preset threshold, Step 209f is performed; otherwise, Step 209g is performed.

Step 209f: determining, by the server, that the category of the advertisement obtained by using the preset classification model is accurate, if the number of product titles, to which the categories correspond obtained from the advertisement classification are respectively the same as the preset categories corresponding to these product titles, reaches the second preset threshold.

The second preset threshold may be set by a technician during development, and may further be adjusted by an advertising agent in use, which is not limited in the embodiments consistent with the present disclosure. Optionally, the second preset threshold may be the ratio of the number of product titles, to which the categories correspond obtained from the advertisement classification are respectively the same as the preset categories corresponding to these product titles, to the number of product titles used for verifying the accuracy of the preset classification model, for example 90%.

It should be noted that, when the server determines that the advertisement category obtained by using the preset classification model is accurate, the server saves the preset classification model, and may classify further advertisements by using the preset classification model.

Step 209g: determining, by the server, that the advertisement category obtained by using the preset classification model is not accurate, if the number of product titles, to which the categories correspond obtained from the advertisement classification are respectively the same as the preset categories corresponding to these product titles, does not reach the second preset threshold.

It should be noted that, when the server determines that the advertisement category obtained by using the preset classification model is not accurate, the server may continue to perform Steps 201 to 208 to adjust the preset classification model or reestablish a preset classification model.

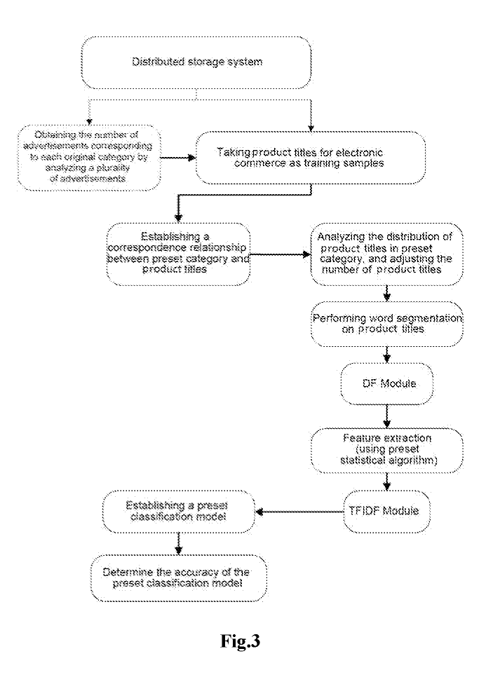

FIG. 3 is a system for embodying the flow of the establishment of a preset classification model according to an embodiment consistent with the present disclosure shown in FIG. 2, especially Steps 201 to 209 shown in FIG. 2. Specifically, the advertisements and the product titles for electronic commerce used for establishing an advertisement classification model may be stored on a distributed storage system, and the number of advertisements corresponding to each original category is obtained by analyzing a plurality of advertisements, so that the correspondence relationship may be adjusted according to the distribution in the original categories and the preset categories during the process of establishing the correspondence relationship by taking the product titles for electronic commerce as training samples, then word segmentation and statistical information computation may be performed on the product titles, and finally a preset classification model may be established, and the accuracy of the preset classification model is verified.

According to the process of Step 209f, if determining that the category of an advertisement obtained by using the preset classification model is accurate, the server may classify further advertisements by using the preset classification model by Steps 210 to 214 below.

Step 210: acquiring, by the server, text information of an advertisement to be classified.

Upon obtaining an advertisement to be classified, the server acquires text information of the advertisement. Further, upon obtaining the advertisement to be classified, the server may also acquire classification information of the advertisement.

Step 211: performing, by the server, word segmentation on the text information to obtain a plurality of words.

Specifically, the server performs word segmentation on the text information of the advertisement according to the process at Step 204, and obtains a plurality of words after an operation such as filtering out a stop word.

Step 212: performing, by the server, feature extraction on the plurality of words, to obtain a plurality of feature words contained in the text information.

Specifically, the server performs feature extraction on the plurality of words according to the process at Step 209b, and finally obtains a plurality of feature words contained in the text information of the advertisement. For the process of performing feature extraction on the plurality of words, reference may be made to the specific process of Step 209b, which is not discussed again here.

Step 213: acquiring by the server, according to statistical information of each of the feature words in the text information and statistical information of the feature word in the known product title, a TFIDF value of the feature word as a weight value of the feature word.

Specifically, the server takes the adjusted product titles corresponding to each preset category obtained from Step 203 as a corpus and takes the product titles corresponding to the preset category as the known product titles, and then obtains the TFIDF value of each of the plurality of feature words as the weight value of the feature word via the formula for calculating the TFIDF value provided in Step 207 according to the number of occurrences of the feature word in the text information, the number of total known product titles as well as the number of occurrences of the feature word in the known product titles.

Step 214: acquiring, by the server, the category of the advertisement according to the weight values of the plurality of feature words, classification information of the advertisement and the preset classification model.

After performing the word segmentation process at Step 211 and the feature extraction process at Step 212 on the classification information according to the classification information of the advertisement, the server obtains a plurality of classification information feature words contained in the classification information; and after performing the process at Step 213 on these classification information feature words, the server obtains a TFIDF value of each of the classification information feature words as a weight value of the classification information feature word, and inputs the weight values of the plurality of classification information feature words and the weight values of the plurality of feature words obtained at Step 212 into the preset classification model for computation, to obtain the category of the advertisement according to the computation result of the preset classification model.

Above Steps 210 to 214 form a process of classifying an advertisement by the server according to a preset classification model. In the embodiment consistent with the present disclosure. However, the method for classifying an advertisement is not limited to the above, and may be alternatively a classification method formed by Steps 215 to 217 below.

Step 215: acquiring by the server, if text information of an advertisement includes specified product information, a specified product category as per a preset correspondence relationship between the product information and the product category according to specified product information, where the specified product category is a product category corresponding to the specified product information, and the specified product information is a specified product identifier and/or a specified product title.

Specifically, the server acquires the text information of the advertisement to be classified at Step 210, and if determining that the text information contains the specified product identifier and/or the specified product title, the server searches out a product category corresponding to the specified product identifier and/or the specified product title according to a correspondence relationship between the product identifier and/or product title and the product category in the server.

It should be noted that, the product identifier may be a product name or a product Identity (ID), etc., which is not limited in the embodiments consistent with the present disclosure.

For example, if the text information of a certain advertisement includes a specified product name of “Samsung S7898”, the server searches out a product category corresponding to the specified product name of “Samsung S7898” according to a correspondence relationship between the product identifier and/or product title and the product category in the server; and if the product category corresponding to the product identifier and/or product title is “mobile phone”, then “Samsung S7898” corresponds to “mobile phone”.

Step 216: acquiring, by the server, a preset category corresponding to the specified product category as per a one-to-many correspondence relationship between the preset category and the product categories according to the specified product category.

Specifically, the server searches out a product category corresponding to the specified product identifier and/or the specified product title as per the correspondence relationship (i.e., the one-to-many correspondence relationship between the preset category and the product categories in the process shown in step 202), to obtain the preset category corresponding to the product category.

Step 217: taking, by the server, the obtained preset category corresponding to the specified product category as the category of the advertisement.

The implementation of the invention further includes a classification method as shown in Steps 218 to 221 below.

Step 218: if the plurality of feature words contain at least one known brand feature word, the server acquires, according to the statistical information of each of the at least one known brand feature word in the text information and the statistical information of the brand feature word in the known product titles, a TFIDF value of the brand feature word as a weight value thereof.

Specifically, after the server performs word segmentation and feature extraction on the text information of the advertisement to obtain the plurality of feature words at Step 212, the server compares these feature words with the brand feature words in the server so as to determine whether the plurality of feature words contain the known brand feature words. If the plurality of feature words contain at least one known brand feature word, the server takes the adjusted product titles corresponding to each preset category at step 203 as a corpus and takes the product titles corresponding to the preset category as the known product titles, and obtains, according to the number of occurrences of the each of the at least one known brand feature word in the text information, the total number of the known product titles as well as the number of occurrences of the brand feature word in the known product titles, a weight value of the brand feature word. For the specific process of obtaining the weight value of each of the brand feature words, reference may be made to the process at Step 207, which is not discussed again here.

The known brand feature word may be set by a technician during development, and may further be adjusted by an advertising agent in use, which is not limited in the embodiments consistent with the present disclosure. The known brand feature word may include Samsung, Nokia, Apple, Jeanswest, Adidas, Nike, etc.

For example, if the plurality of feature words contain three brand feature words, i.e., Samsung, Nokia and Apple, the server computes the weight values of these three brand feature words via the formula in Step 207.

Step 219: obtaining by the server, the preset category corresponding to each of the brand feature words according to a correspondence relationship between the known brand feature word and the product category as well as a one-to-many correspondence relationship between the preset category and the product categories.

Specifically, the server searches out the product category corresponding to each of the brand feature words according to a correspondence relationship between the known brand feature word and the product category, and then obtains the preset category that corresponds to the product category corresponding to the brand feature word according to the one-to-many correspondence relationship between the preset category and the product categories, thereby obtaining the preset category corresponding to the brand feature word.

Based on the example in Step 218, the server obtains that the preset categories corresponding to the two brand feature words, i.e., Samsung and Nokia, are both mobile phone and the preset category corresponding to the brand feature word “Apple” is fruit, according to a correspondence relationship between the known brand feature word and the product category and a one-to-many correspondence relationship between the preset category and the product categories.

Step 220: adding, by the server, the weight values of the brand feature words that belong to the same preset category, to obtain a weight value of the preset category corresponding to the brand feature words.

It should be noted that, the weight value of the preset category is a sum of the weight values of all the brand feature words contained in the preset category.

Based on the example in Step 219, if the weight values of the two brand feature words, i.e., Samsung and Nokia, that are computed and obtained at Step 218 are respectively 0.8 and 0.6, and the weight value of the brand feature word “Apple” is 0.3, the weight value of the preset category of mobile phone is 1.4 which is a sum of 0.8 and 0.6, and the weight value of the preset category of fruit is 0.3.

Step 221: selecting by the server, among the preset categories corresponding to the at least one brand feature word, a preset category with the largest weight value as the category of the advertisement.

Based on the example in Step 220, because the weight value 1.4 of the preset category of mobile phone is larger than the weight value 0.3 of the preset category of fruit, the preset category of mobile phone is selected as the category of the advertisement, that is, the category of the advertisement is mobile phone.

In the embodiment consistent with the present disclosure, to classify an advertisement, the server will classify the advertisement according to one or more of the above three classification methods so as to obtain a plurality of classification results; that is, when the whole classification process contains the processes at Steps 210 to 221, preferably, the server takes the classification result obtained by the processes at Steps 215 to 217 as the resultant category of the advertisement; when the whole classification process contains the processes at Steps 210 to 214 and Steps 218 to 221, the server takes the classification result obtained by Steps 218 to 221 as the resultant category of the advertisement; and when the whole classification process only contains the processes at Steps 210 to 214, the server takes the classification result obtained by the preset classification model as the resultant category of the advertisement. However, the above process is only a preferred processing mode, and other processing modes may also be adopted in an actual application. In the embodiment consistent with the present disclosure, the priorities of the classification results of the three classification methods are not limited.

The above three methods for classifying an advertisement are carried out sequentially. However, the above three methods for classifying an advertisement may also be carried out in any order; for example, the classification process shown in Steps 218 to 221 is carried out first, then the classification process shown in Steps 215 to 217 is carried out, and finally the classification process shown in Steps 210 to 214 is carried out. The above three methods for classifying an advertisement may also be carried out simultaneously. In the embodiment consistent with the present disclosure, the order for carrying out the three methods for classifying an advertisement is not limited.

After classifying the advertisement, the embodiment consistent with the present disclosure may further include: pushing, by the server, the advertisement according to the category of the advertisement. For example, when the category of the advertisement is mobile phone, the server pushes the advertisement to users who are interested in mobile phones. Conventionally, an advertisement is pushed to target users based on historical behavior information, for example, an exposure situation of the advertisement or user clicks on the advertisement. However, for a new advertisement, the historical behavior information (for example, the exposure situation of the new advertisement or user clicks on the new advertisement) is unavailable in a short time, thus the advertisement might be pushed aimlessly in the prior art, so that the effect of the advertisement is poor. However, with the advertisement classifying method according to the embodiment consistent with the present disclosure, the product titles corresponding to each preset category are employed as a corpus for advertisement classification, thus the advertisement may be classified at greatly improved accuracy, so that an advertisement can be pushed in a customized and individualized way, and the problem of the prior art that a new advertisement cannot be pushed to a user who is interested in this advertisement because historical behavior information such as exposure situations of the advertisement and user clicks on the advertisement is unavailable is solved.

After the advertisement classification, the method for advertisement classification may further include a process of optimizing the preset classification model according to the classification result, as shown in Step 222.

Step 222: if the category of the advertisement obtained from the classification is the same as the preset category of the advertisement, the server trains the present classification model using the advertisement, to obtain an optimized preset classification model.

Specifically, after obtaining the category of the advertisement by any one of the above three methods, the server determines the resultant category of the advertisement according to the priorities of the three classification methods and compares the resultant category with the preset category of the advertisement; if the resultant category is the same as the preset category of the advertisement, the server determines that the classification result of the advertisement is correct, and stores the advertisements that are classified correctly as a training set for training the preset classification model, so that the preset classification model may be optimized and updated, to obtain the optimized preset classification model.

The specific process for obtaining the preset category of the advertisement includes: obtaining, by an advertising agent, the preset category to which the advertisement belongs by analyzing the advertisement.

It should be noted that, after the server obtains the optimized preset classification model, the optimized preset classification model is stored. Subsequently, when it is required to classify an advertisement, the server classifies the advertisement according to the optimized preset classification model.

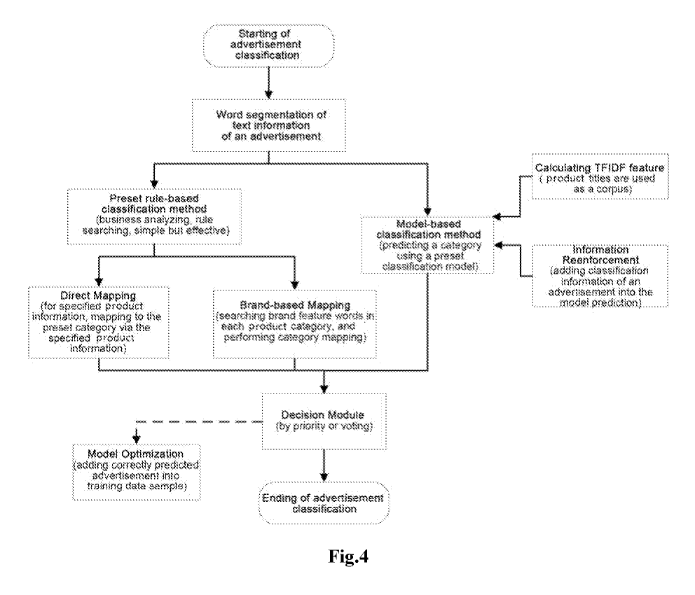

FIG. 4 is a flow chart showing the classification of advertisements according to an embodiment consistent with the present disclosure. Referring to FIG. 4, the flow chart includes the classification processes of the above-described three methods, i.e., direct advertisement mapping, brand-based mapping and model-based classification. As shown, word segmentation is performed on text information of an advertisement and a word segmentation result is subjected to those three methods, i.e., direct mapping, brand-based mapping and model-based classification, to obtain a plurality of categories. Then, one of the obtained plurality of categories is selected as the category of the advertisement by a decision module as per priorities of those three methods or voting. However, when it is determined that the classification of the advertisement is accurate, the advertisement that is classified correctly may be added to the training sample.

With the method according to the present embodiment consistent with the present disclosure, a plurality of feature words are obtained from the text information of an advertisement to be classified, and the product title corresponding to each preset category is regarded as a known product title and added to a corpus, to avoid selecting the data from the advertisement in a manner of manual labeling, so that the time taken for advertisement classification is reduced. At the same time, in classifying an advertisement, the server additionally introduces the feature corresponding to the classification information of the advertisement to a preset classification model for computation in order to obtain the category of the advertisement, thus avoiding the low precision in classifying the advertisement according to a feature word obtained from the text information and a separate preset classification model merely, so that the precision of advertisement classification may be improved.

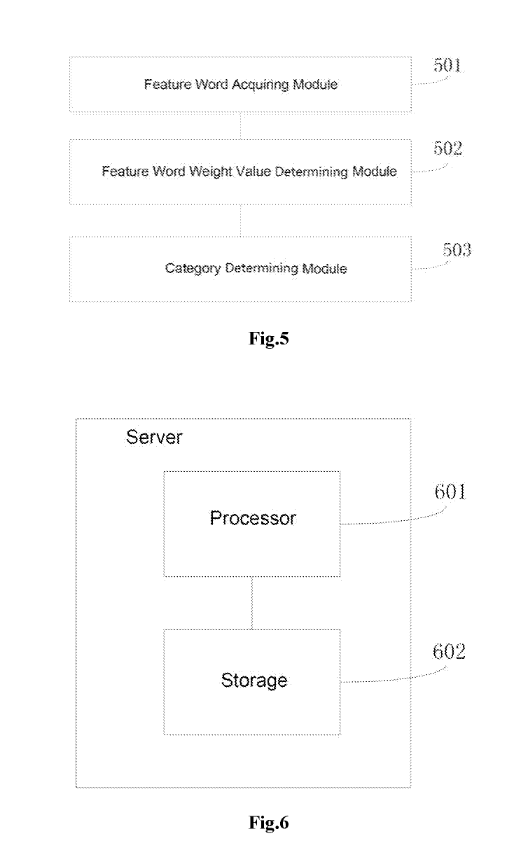

FIG. 5 is a structural representation of a device for advertisement classification according to an embodiment consistent with the present disclosure. Referring to FIG. 5, the device includes: a feature word acquiring module 501, a feature word weight value determining module 502 and a category determining module category determining module 503, where the feature word acquiring module 501 is configured for obtaining, from text information of an advertisement to be classified, a plurality of feature words of the text information; the feature word weight value determining module 502 is connected with the feature word acquiring module 501, and is configured for acquiring, according to statistical information of each of the feature words in the text information and statistical information of the feature word in the known product titles, a TFIDF value of the feature word as the weight value of the feature word; and the category determining module category determining module 503 is connected with the feature word weight value determining module 502, and is configured for acquiring a category of the advertisement according to the weight values of the plurality of feature words, classification information of the advertisement and a preset classification model.

Optionally, the feature word weight value determining module 502 is specifically configured for acquiring, according to the number of occurrences of each of the feature words in the text information, the total number of known product titles and the number of occurrences of the feature word in the known product titles, the TFIDF value of the feature word as the weight value of the feature word.

Optionally, the feature word acquiring module 501 is specifically configured for: acquiring the text information of an advertisement to be classified; performing word segmentation on the text information to obtain a plurality of words; and performing feature extraction on the plurality of words to obtain the plurality of feature words of the text information.

Optionally, the device for advertisement classification further includes: a specified product category determining module, which is configured for acquiring, when the text information of the advertisement includes specified product information, a specified product category as per a correspondence relationship between the preset product information and the product category according to specified product information, where the specified product category is a product category corresponding to the specified product information, and the specified product information is a specified product identifier and/or a specified product title; and a preset category determining module category determining module, which is configured for acquiring a preset category corresponding to the specified product category as per a one-to-many correspondence relationship between the preset category and the product categories according to the specified product category.

The category determining module category determining module 503 is further configured for acquiring the preset category corresponding to the specified product category as the category of the advertisement.

Optionally, the device for advertisement classification further includes: a brand feature word weight value determining module, which is configured for acquiring, when the plurality of feature words contain at least one known brand feature word, a TFIDF value of each brand feature word of the at least one known brand feature word as a weight value of the brand feature word according to the statistical information of the brand feature word in the text information and the statistical information of the brand feature word in the known product title.

The preset category determining module category determining module is further configured for obtaining a preset category corresponding to each brand feature word according to a correspondence relationship between the known brand feature word and the product category and a one-to-many correspondence relationship between the preset category and the product categories.

The device for advertisement classification further includes: a preset category weight value determining module, which is configured for adding the weight values of the brand feature words that belong to the same preset category, to obtain a weight value of the preset category corresponding to the brand feature words.

The category determining module category determining module 503 is further configured for selecting, among the preset categories corresponding to the least one brand feature word, the preset category with the largest weight value as the category of the advertisement.

Optionally, the device for advertisement classification further includes: a model optimization module, which is configured for training the preset classification model according to the advertisement to obtain an optimized preset classification model, when the obtained category of the advertisement is the same as the preset category of the advertisement.

Optionally, the preset category determining module category determining module is configured for acquiring preset categories corresponding to a plurality of advertisements. The device for advertisement classification further includes: a product title acquiring module, which is configured for acquiring the product titles corresponding to each one from the acquired preset categories according to the one-to-many correspondence relationship between the preset category and the product categories; and a model establishing module, which is configured for establishing the preset classification model according to the product titles corresponding to the preset categories.

Optionally, the device for advertisement classification further includes: a product title adjusting module, which is configured for adjusting the product titles corresponding to each preset category according to the number of advertisements corresponding to each original category, so as to equalize the number of the product titles corresponding to each preset category, where the original category is a category determined by the advertisement owner; and a product title selecting module, which is configured for selecting product titles of a preset proportion from the adjusted product titles corresponding to each preset category, so that the preset classification model may be established based on the selected product titles in the preset proportion.

Optionally, the model establishing module includes: a title feature word acquiring unit, which is configured for acquiring a plurality of title feature words from the product titles of a preset proportion selected from the adjusted product titles corresponding to each preset category; a title feature word weight value acquiring unit, which is configured for acquiring a TFIDF value of each title feature word as the weight value of this title feature word according to the number of occurrences this title feature word in the corresponding product title, the number of the selected product titles in the preset proportion and the number of occurrences this title feature word in the selected product titles in the preset proportion; and a model establishing unit, which is configured for establishing the preset classification model according to the weight values of the title feature words and a preset classification algorithm.

Optionally, the title feature word acquiring unit is specifically configured for: performing word segmentation on the product titles of a preset proportion selected from the adjusted product titles corresponding to each preset category, to obtain a word segmentation result of each product title; acquiring, according to the number of occurrences for which each word from the word segmentation result of each product title occurs in the selected product titles in the preset proportion, words of which the numbers of occurrences in the selected product titles in the preset proportion are larger than a first preset threshold; and performing feature extraction on the words of which the numbers of occurrences are larger than the first preset threshold by using a preset statistical algorithm, to obtain a plurality of title feature words.

Optionally, the category determining module category determining module 503 is further configured for selecting, among the product titles corresponding to each preset category, product titles except for the selected product titles in the preset proportion as advertisements, and obtaining the category corresponding to each one from the product titles except for the selected product titles in the preset proportion according to the product titles except for the selected product titles in the preset proportion and the preset classification model.

The device for advertisement classification further includes: a judging module, which is configured for judging whether the obtained category corresponding to each product title is the same as the preset category corresponding to this product title; and an accuracy determining module, which is configured for acquiring the accuracy of obtaining an advertisement category by the preset classification model, if the number of product titles (among the product titles except for the selected product titles in the preset proportion), to which the categories correspond obtained from the advertisement classification are respectively the same as the preset categories corresponding to these product titles, reaches a second preset threshold.

Optionally, the category determining module category determining module 503 is specifically configured for: performing word segmentation on each product title from the product titles except for the selected product titles in the preset proportion, to obtain a word segmentation result of this product title; performing feature extraction on the words in the word segmentation result of the product title, to obtain a plurality of words; acquiring a TFIDF value of each word from the plurality of words as the weight value of this word according to the number of occurrences this word in the product titles corresponding to this word, the number of the product titles except for the selected product titles in the preset proportion and the number of occurrences of this word in the product titles except for the selected product titles in the preset proportion; and inputting the weight value of each word from the plurality of words into the preset classification model for computation, to obtain the category corresponding to each product title from the product titles except for the selected product titles in the preset proportion.

With the device for advertisement classification according to the present embodiment consistent with the present disclosure, a plurality of feature words are obtained from the text information of an advertisement to be classified, and the product title corresponding to each preset category is regarded as a known product title and added to a corpus, to avoid selecting the data from the advertisement in a manner of manual labeling, so that the time taken for advertisement classification is reduced. At the same time, in classifying an advertisement, the server additionally introduces the feature corresponding to the classification information of the advertisement to a preset classification model for computation in order to obtain the category of the advertisement, thus avoiding the low precision in classifying the advertisement according to a feature word obtained from the text information and a separate preset classification model merely, so that the precision of advertisement classification may be improved.

It should be noted that, for the description of the advertisement classification performed by the device for advertisement classification according to the above embodiment, the division of the device into the above functional modules is illustrative. However, in an actual application, the device may be divided into different functional modules for performing the corresponding functions as desired, that is, the internal structure of the device may be divided into different functional modules to accomplish the whole or a part of the functions described above. Additionally, the embodiments of the device for advertisement classification and the method for advertisement classification described above belong to the same concept, and reference may be made to the method embodiment for the specific implementing of the device, which will not be given here.

FIG. 6 is a structural representation of a server according to an embodiment consistent with the present disclosure. Referring to FIG. 6, the server includes a processor 601 and a storage 602, which are connected with each other.

The processor 601 is configured for obtaining a plurality of feature words of text information of an advertisement to be classified, according to the text information.

The processor 601 is further configured for acquiring a Term Frequency-Inverse Document Frequency value of each feature word as a weight value of this feature word according to the statistical information of this feature word in the text information and the statistical information of this feature word in the known product title.

The processor 601 is further configured for acquiring the category of the advertisement according to the weight value of each feature word, the classification information of the advertisement and a preset classification model.

Optionally, the processor 601 is further configured for acquiring a TFIDF value of each feature word as the weight value of this feature word according to the number of occurrences of this feature word in the text information, the total number of known product titles and the number of occurrences of this feature word in the known product title.

Optionally, the processor 601 is further configured for: acquiring the text information of an advertisement to be classified; performing word segmentation on the text information to obtain a plurality of words; and performing feature extraction on the plurality of words to obtain a plurality of feature words of the text information.

Optionally, the processor 601 is further configured for acquiring, if the text information of the advertisement includes specified product information, a specified product category as per a preset correspondence relationship between the product information and the product category according to specified product information, where the specified product category is a product category corresponding to the specified product information, and the specified product information is a specified product identifier and/or a specified product title.

The processor 601 is further configured for acquiring a preset category corresponding to the specified product category as per a one-to-many correspondence relationship between the preset category and the product categories according to the specified product category.

The processor 601 is further configured for acquiring the preset category corresponding to the specified product category as the category of the advertisement.

Optionally, the processor 601 is further configured for acquiring, if the plurality of feature words contain at least one known brand feature word, a TFIDF value of each brand feature word from the at least one known brand feature word as a weight value of this brand feature word, according to the statistical information of this brand feature word in the text information and the statistical information of this brand feature word in the known product title.

The processor 601 is further configured for obtaining a preset category corresponding to each brand feature word according to a correspondence relationship between the known brand feature word and the product category and a one-to-many correspondence relationship between the preset category and the product categories.

The processor 601 is further configured for adding the weight values of the brand feature words that belong to the same preset category, to obtain a weight value of the preset category corresponding to the brand feature words.

The processor 601 is further configured for selecting, among the preset categories corresponding to the at least one brand feature word, a preset category with the largest weight value as the category of the advertisement.

Optionally, the processor 601 is further configured for training the preset classification model by using the advertisement to obtain an optimized preset classification model, if the category of the advertisement is the same as the preset category of the advertisement.

Optionally, the processor 601 is further configured for acquiring preset categories corresponding to a plurality of advertisements.

The processor 601 is further configured for acquiring the product titles corresponding to each one from the preset categories according to the one-to-many correspondence relationship between the preset category and the product categories.

The processor 601 is further configured for establishing the preset classification model according to the product titles corresponding to each preset category.

Optionally, the processor 601 is further configured for adjusting the product titles corresponding to each preset category according to the number of advertisements corresponding to each original category, so as to equalize the number of the product titles corresponding to each preset category, where the original category is a category determined by the advertisement owner.

The processor 601 is further configured for selecting product titles of a preset proportion from the adjusted product titles corresponding to each preset category, and establishing the preset classification model based on the selected product titles in the preset proportion.

Optionally, the processor 601 is further configured for: acquiring a plurality of title feature words from the product titles of a preset proportion selected from the adjusted product titles corresponding to each preset category; acquiring a TFIDF value of each title feature word as the weight value of this title feature word according to the number of occurrences this title feature word in the corresponding product title, the number of the selected product titles in the preset proportion and the number of occurrences this title feature word in the selected product titles in the preset proportion; and establishing the preset classification model according to the weight values of the title feature words and a preset classification algorithm.

Optionally, the processor 601 is further configured for: performing word segmentation on the product titles of a preset proportion selected from the adjusted product titles corresponding to each preset category, to obtain a word segmentation result of each product title; acquiring, according to the number of occurrences for which each word from the word segmentation result of each product title occurs in the selected product titles in the preset proportion, words of which the numbers of occurrences in the selected product titles in the preset proportion are larger than a first preset threshold; and performing feature extraction on the words of which the numbers of occurrences are larger than the first preset threshold by using a preset statistical algorithm, to obtain a plurality of title feature words.

Optionally, the processor 601 is further configured for selecting, among the product titles corresponding to each preset category, product titles except for the selected product titles in the preset proportion as advertisements, and obtaining the category corresponding to each one from the product titles except for the selected product titles in the preset proportion according to the product titles except for the selected product titles in the preset proportion and the preset classification model.

The processor 601 is further configured for judging whether the obtained category corresponding to each product title is the same as the preset category corresponding to this product title.

The processor 601 is further configured for acquiring the accuracy of obtaining an advertisement category by the preset classification model, if the number of product titles (among the product titles except for the selected product titles in the preset proportion), to which the categories correspond obtained from the advertisement classification are respectively the same as the preset categories corresponding to these product titles, reaches a second preset threshold.

Optionally, the processor 601 is further configured for: performing word segmentation on each product title from the product titles except for the selected product titles in the preset proportion, to obtain a word segmentation result of this product title; performing feature extraction on the words in the word segmentation result of the product title, to obtain a plurality of words; acquiring a TFIDF value of each word from the plurality of words as the weight value of this word according to the number of occurrences this word in the product titles corresponding to this word, the number of the product titles except for the selected product titles in the preset proportion and the number of occurrences of this word in the product titles except for the selected product titles in the preset proportion; and inputting the weight value of each word from the plurality of words into the preset classification model for computation, to obtain the category corresponding to each product title from the product titles except for the selected product titles in the preset proportion.

An embodiment consistent with the present disclosure further provides a storage medium containing computer-executable instructions, which, when executed by a computer processor, are configured to perform a method for advertisement classification including: obtaining a plurality of feature words of text information of an advertisement to be classified, according to the text information; acquiring a term frequency-inverse document frequency (TFIDF) value of each feature word from the plurality of feature words as a weight value of this feature word according to the statistical information of this feature word in the text information and the statistical information of this feature word in the known product title; and acquiring the category of the advertisement according to the weight value of each feature word, the classification information of the advertisement and a preset classification model.

The executable instructions contained in the storage medium according to the embodiment consistent with the present disclosure are not limited to performing the above steps of the method; instead, the executable instructions may also perform a method for advertisement classification according to any embodiment consistent with the present disclosure.

With the description of the above embodiments, one skilled in the art may clearly understand that the invention may be implemented by the aid of software and necessary universal hardware; of course, the invention may be implemented by hardware. However, in many cases, the former is preferred. Based on such an understanding, the essential part of the technical solutions of the invention, or in other words, the part that contributes to the prior art, may be embodied in the form of a software product that is stored in a computer-readable storage medium, for example, floppy disk, Read-Only Memory (ROM), Random Access Memory (RAM), FLASH, hard disk, compact disc, etc. of a computer, and includes several instructions that can make a computer device (which may be a personal computer, a server or a network device, etc.) implement the methods according to various embodiments consistent with the present disclosure.

It should be noted that in the above embodiment of the device for advertisement classification, each unit and module included are only divided according to functional logic; however, the invention will not be limited to the above division, so long as the corresponding functions can be implemented; additionally, the specific name of each functional unit is only configured for easy distinguish, rather than limiting the protection scope of the invention.

The above description only shows some preferred embodiments consistent with the present disclosure, rather than limiting the scope of the invention. All modifications, equivalent substitutions and improvements made by one skilled in the art without departing from the spirit and principles of the invention should be contemplated by the protection scope of the invention. Therefore, the protection scope of the invention should be defined by the appended claims.

What is claimed is:

1. A method for advertisement classification, comprising:
obtaining, according to text information of an advertisement to be classified, a plurality of feature words of the text information;
determining a Term Frequency-Inverse Document Frequency (TFIDF) value of each feature word from the plurality of feature words according to statistical information of the feature word in the text information and statistical information of the feature word in known product titles, the Term Frequency-Inverse Document Frequency value being a weight value of the feature word; and
determining a category of the advertisement according to the weight values of the plurality of feature words, classification information of the advertisement and a preset classification model.

2. The method of claim 1, wherein the determining a Term Frequency-Inverse Document Frequency value of each feature word from the plurality of feature words further comprises:
determining a Term Frequency-Inverse Document Frequency value of each feature word from the plurality of feature words according to the number of occurrences of the feature word in the text information, the total number of known product titles and the number of occurrences of the feature word in the known product titles, the Term Frequency-Inverse Document Frequency value being a weight value of the feature word.

3. The method of claim 1, wherein, the determining, according to text information of an advertisement to be classified, a plurality of feature words of the text information comprises:
acquiring the text information of the advertisement to be classified;
performing word segmentation on the text information to obtain a plurality of words; and
performing feature extraction on the plurality of words to obtain the plurality of feature words of the text information.

4. The method of claim 1, further comprising:
if the text information of the advertisement contains specified product information, acquiring a specified product category as per a preset correspondence relationship between the product information and the product category according to the specified product information, wherein the specified product category is a product category corresponding to the specified product information, and the specified product information is a specified product identifier or a specified product title;
acquiring a preset category corresponding to the specified product category as per a one-to-many correspondence relationship between the preset category and the product categories according to the specified product category; and
acquiring the preset category corresponding to the specified product category as the category of the advertisement.

5. The method of claim 1, further comprising:
if the plurality of feature words contain at least one known brand feature word, acquiring a Term Frequency-Inverse Document Frequency value of each brand feature word from the at least one known brand feature word as a weight value of the brand feature word, according to statistical information of the brand feature word in the text information and statistical information of the brand feature word in the known product titles;
obtaining a preset category corresponding to each brand feature word from the at least one known brand feature word according to a correspondence relationship between the brand feature word and the product category and a one-to-many correspondence relationship between the preset category and the product categories;
adding the weight values of brand feature words that belong to the same preset category, to obtain a weight value of the preset category corresponding to the brand feature words; and
selecting, among the preset categories corresponding to the at least one known brand feature word, a preset category with the largest weight value as the category of the advertisement.

6. The method of claim 1, wherein, after the determining a category of the advertisement, the method further comprises:
if the category of the advertisement is the same as the preset category of the advertisement, training the preset classification model according to the advertisement to obtain an optimized preset classification model.

7. The method of claim 1, further comprising:
determining preset categories corresponding to a plurality of advertisements;
acquiring product titles corresponding to each preset category from the preset categories according to a one-to-many correspondence relationship between the preset category and the product categories; and
establishing the preset classification model according to the product titles corresponding to the preset category.

8. The method of claim 7, wherein, after the acquiring product titles corresponding to each preset category from the preset categories according to a one-to-many correspondence relationship between the preset category and the product categories, the method further comprises:
adjusting the product titles corresponding to each preset category according to the number of advertisements corresponding to each original category, so as to equalize the number of the product titles corresponding to each preset category, wherein the original category is a category determined by an advertisement owner; and
selecting product titles in a preset proportion from the adjusted product titles corresponding to each preset category, and establishing the preset classification model according to the selected product titles in the preset proportion.

9. The method of claim 7, wherein, the establishing the preset classification model according to the product title corresponding to the preset category comprises:
determining a plurality of title feature words according to the selected product titles in the preset proportion from the adjusted product titles corresponding to each preset category;
determining a Term Frequency-Inverse Document Frequency value of each title feature word from the plurality of title feature words as a weight value of the title feature word, according to the number of occurrences of the title feature word in the corresponding product titles, the number of the selected product titles in the preset proportion as well as the number of occurrences of the title feature word in the selected product titles in the preset proportion; and
establishing the preset classification model according to the weight values of the plurality of title feature words and a preset classification algorithm.

10. The method of claim 9, wherein, the acquiring a plurality of title feature words according to the adjusted product titles corresponding to each preset category comprises:
performing word segmentation on the selected product titles in the preset proportion from the adjusted product titles corresponding to each preset category, so as to obtain a word segmentation result of each of the product titles;
acquiring, according to the number of occurrences of each of the words from the segmentation result of each of the product titles in the selected product titles in the preset proportion, words of which the numbers of occurrences are larger than a first preset threshold; and
performing feature extraction using a preset statistical algorithm according to the words of which the numbers of occurrences are larger than the first preset threshold, to obtain the plurality of title feature words.

11. The method of claim 7, wherein, after the establishing the preset classification model according to the product titles corresponding to each preset category, the method further comprises:
selecting product titles corresponding to each preset category except for the selected product titles in the preset proportion as advertisements, and acquiring the category corresponding to each of the product titles except for the selected product titles in the preset proportion according to the product titles except for the selected product titles in the preset proportion and the preset classification model;
determining whether the category corresponding to each of the product titles except for the selected product titles in the preset proportion is the same as the preset category corresponding to the product title; and
determining the accuracy of obtaining the category of the advertisement by the preset classification model, if the number of product titles from the product titles except for the selected product titles in the preset proportion, to which the categories correspond are respectively the same as the preset categories corresponding to which, reaches a second preset threshold.

12. The method of claim 11, wherein, the acquiring the category corresponding to each of the product titles except for the selected product titles in the preset proportion according to the product titles except for the selected product titles in the preset proportion and the preset classification model comprises:
performing word segmentation on each of the product titles except for the selected product titles in the preset proportion, to obtain the word segmentation result of the product title;
performing feature extraction on words in the word segmentation result of the product title to obtain a plurality of words;
determining a Term Frequency-Inverse Document Frequency value of each of the obtained plurality of words as the weight value of the word, according to the number of occurrences of the word in the product title corresponding to the word, the number of the product titles except for the selected product titles in the preset proportion as well as the number of occurrences of the word in the product titles except for the selected product titles in the preset proportion; and
inputting the weight values of the plurality of words into the preset classification model for computation, in order to acquire the category corresponding to each of the product titles except for the selected product titles in the preset proportion.

13. A device for advertisement classification, comprising:
a feature word acquiring module, which is configured for obtaining, from text information of an advertisement to be classified, a plurality of feature words of the text information;
a feature word weight value determining module, which is configured for acquiring a Term Frequency-Inverse Document Frequency value of each feature word from the plurality of feature words as a weight value of the feature word, according to statistical information of the feature word in the text information and statistical information of the feature word in known product titles; and
a category determining module category determining module, which is configured for acquiring a category of the advertisement according to the weight values of the plurality of feature words, classification information of the advertisement and a preset classification model.

14. The device of claim 13, wherein, the feature word weight value determining module is configured for acquiring a Term Frequency-Inverse Document Frequency value of each feature word from the plurality of feature words as a weight value of the feature word, according to the number of occurrences of the feature word in the text information, the total number of known product titles and the number of occurrences of the feature word in the known product titles.

15. The device of claim 13, wherein, the feature word acquiring module is configured for: acquiring the text information of the advertisement to be classified; performing word segmentation on the text information to obtain a plurality of words; and performing feature extraction on the plurality of words to obtain the plurality of feature words of the text information.

16. The device of claim 13, further comprising:
a specified product category determining module, which is configured for, if the text information of the advertisement contains specified product information, acquiring a specified product category as per a preset correspondence relationship between the product information and the product category according to the specified product information, wherein the specified product category is a product category corresponding to the specified product information, and the specified product information is a specified product identifier and/or a specified product title;
a preset category determining module category determining module, which is configured for acquiring a preset category corresponding to the specified product category as per a one-to-many correspondence relationship between the preset category and the product categories according to the specified product category; and
the category determining module category determining module is further configured for acquiring the preset category corresponding to the specified product category as the category of the advertisement.

17. The device of claim 13, further comprising:
a brand feature word weight value determining module, which is configured for, if the plurality of feature words contain at least one known brand feature word, acquiring a Term Frequency-Inverse Document Frequency value of each brand feature word from the at least one known brand feature word as a weight value of the brand feature word, according to statistical information of the brand feature word in the text information and statistical information of the brand feature word in the known product titles;
the preset category determining module category determining module is further configured for obtaining a preset category corresponding to each brand feature word from the at least one known brand feature word according to a correspondence relationship between the brand feature word and the product category and a one-to-many correspondence relationship between the preset category and the product categories; and
the device further comprises: a preset category weight value determining module, which is configured for adding the weight values of brand feature words that belong to the same preset category, to obtain a weight value of the preset category corresponding to the brand feature words;
the category determining module category determining module is further configured for selecting, among the preset categories corresponding to the at least one known brand feature word, a preset category with the largest weight value as the category of the advertisement.

18. The device of claim 13, further comprising:
a model optimization module, which is configured for, if the category of the advertisement is the same as the preset category of the advertisement, training the preset classification model according to the advertisement to obtain an optimized preset classification model.

19. The device of claim 13, wherein, the preset category determining module category determining module is further configured for acquiring preset categories corresponding to a plurality of advertisements;
the device further comprises:
a product title acquiring module, which is configured for acquiring product titles corresponding to each preset category from the preset categories according to a one-to-many correspondence relationship between the preset category and the product categories; and
a model establishing module, which is configured for establishing the preset classification model according to the product titles corresponding to the preset category.

20. The device of claim 19, further comprising:
a product title adjusting module, which is configured for adjusting the product titles corresponding to each preset category according to the number of advertisements corresponding to each original category, so as to equalize the number of the product titles corresponding to each preset category, wherein the original category is a category determined by an advertisement owner; and
a product title selecting module, which is configured for selecting product titles in a preset proportion from the adjusted product titles corresponding to each preset category, and establishing the preset classification model according to the selected product titles in the preset proportion.

21. The device of claim 19, wherein, the model establishing module comprises:
a title feature word acquiring unit, which is configured for acquiring a plurality of title feature words according to the selected product titles in the preset proportion from the adjusted product titles corresponding to each preset category;
a title feature word weight value acquiring unit, which is configured for acquiring a Term Frequency-Inverse Document Frequency value of each title feature word from the plurality of title feature words as a weight value of the title feature word, according to the number of occurrences of the title feature word in the corresponding product titles, the number of the selected product titles in the preset proportion as well as the number of occurrences of the title feature word in the selected product titles in the preset proportion; and
a model establishing unit, which is configured for establishing the preset classification model according to the weight values of the plurality of title feature words and a preset classification algorithm.

22. The device of claim 21, wherein, the title feature word acquiring unit is configured for: performing word segmentation on the selected product titles in the preset proportion from the adjusted product titles corresponding to each preset category, so as to obtain a word segmentation result of each of the product titles; acquiring, according to the number of occurrences of each of the words from the segmentation result of each of the product titles in the selected product titles in the preset proportion, words of which the numbers of occurrences are larger than a first preset threshold; and performing feature extraction using a preset statistical algorithm according to the words of which the numbers of occurrences are larger than the first preset threshold, to obtain the plurality of title feature words.

23. The device of claim 19, wherein, the category determining module category determining module is further configured for: selecting product titles corresponding to each preset category except for the selected product titles in the preset proportion as advertisements, and acquiring the category corresponding to each of the product titles except for the selected product titles in the preset proportion according to the product titles except for the selected product titles in the preset proportion and the preset classification model;
the device further comprises:
a determining module, which is configured for determining whether the category corresponding to each of the product titles except for the selected product titles in the preset proportion is the same as the preset category corresponding to the product title; and
an accuracy determining module, which is configured for acquiring the accuracy of obtaining the category of the advertisement by the preset classification model, if the number of product titles from the product titles except for the selected product titles in the preset proportion, to which the categories correspond are respectively the same as the preset categories corresponding to which, reaches a second preset threshold.

24. The device of claim 23, wherein, the category determining module category determining module is configured for: performing word segmentation on each of the product titles except for the selected product titles in the preset proportion, to obtain the word segmentation result of the product title; performing feature extraction on words in the word segmentation result of the product title to obtain a plurality of words; acquiring a Term Frequency-Inverse Document Frequency value of each of the obtained plurality of words as the weight value of the word, according to the number of occurrences of the word in the product title corresponding to the word, the number of the product titles except for the selected product titles in the preset proportion as well as the number of occurrences of the word in the product titles except for the selected product titles in the preset proportion; and inputting the weight values of the plurality of words into the preset classification model for computation, in order to determine the category corresponding to each of the product titles except for the selected product titles in the preset proportion.

25. A server comprising: a processor and a storage which are connected with each other; wherein:
the processor is configured for obtaining, according to text information of an advertisement to be classified, a plurality of feature words of the text information;
the processor is further configured for acquiring a Term Frequency-Inverse Document Frequency value of each feature word from the plurality of feature words as a weight value of the feature word, according to statistical information of the feature word in the text information and statistical information of the feature word in known product titles; and
the processor is further configured for determining a category of the advertisement according to the weight values of the plurality of feature words, classification information of the advertisement and a preset classification model.

26. A storage medium containing computer-executable instructions, wherein the computer-executable instructions, when executed by a computer processor, are configured to perform a method for advertisement classification comprising:
obtaining, according to text information of an advertisement to be classified, a plurality of feature words of the text information;
acquiring a Term Frequency-Inverse Document Frequency value of each feature word from the plurality of feature words as a weight value of the feature word, according to statistical information of the feature word in the text information and statistical information of the feature word in known product titles; and
determining a category of the advertisement according to the weight values of the plurality of feature words, classification information of the advertisement and a preset classification model.
